(19) United States
(12) Patent Application Publication
(10) Pub. No.: US 2012/0248122 A1
(43) Pub. Date: Oct. 4, 2012

(54) CARTRIDGE INSTALLED IN A PRESSURED TANK TO IMPROVE THE STORAGE CAPACITY OF METHANE OR HYDROGEN GAS

(76) Inventor: Craig Hageman, Arlington Heights, IL (US)

(21) Appl. No.: 13/435,960

(22) Filed: Mar. 30, 2012

Related U.S. Application Data
(60) Provisional application No. 61/471,539, filed on Apr. 4, 2011.

(51) Int. Cl. B62D 33/00; B65D 6/00; D03D 15/00; B05D 3/02; B32B 9/02; B32B 5/02

(52) U.S. Cl. 220/562; 428/426; 428/332; 442/181; 427/372.2; 220/660

(57) ABSTRACT

A cartridge is formed from a rolled bilayer including a fiberglass layer acting as a stabilizing substrate, and carbon layer formed from bird feathers. The cartridge creates adsorptive nano pockets, and is inserted into a tank for increasing the capacity for storage of methane and hydrogen gas stored within.

This application claims the benefit of U.S. provisional patent application Ser. No. 61/471,539, which was filed on Apr. 4, 2011.

### BACKGROUND OF THE INVENTION

The present invention relates to the storage of methane and hydrogen gas. More specifically, it pertains to a cartridge formed of a rolled bilayer of fiberglass and carbon, with bird feathers providing the carbon source.

Methane and hydrogen gas are very important and environmentally friendly fuel sources, but problematic in some respects. For example, these materials are difficult to store given they each contain positive charges which repel each other. Also, they must be stored at cold temperatures and at high pressures, which is both expensive and dangerous. In order to comply with safety parameters, storage tanks don't actually store as much gas by volume as they could. Accordingly, items powered from these methane and hydrogen tanks (i.e., LP tanks) run out of fuel sooner, or require that tanks be replaced more frequently.

As can be seen, there is a need for a system that improves the storage capacity of methane and hydrogen. Ideally this system is safe, environmentally friendly, uses components that are inexpensive and is easy to manufacture and distribute.

### BRIEF DESCRIPTION OF THE DRAWINGS

FIG. 1 is a side view of the cartridge being rolled;

FIG. 2 is a perspective view of the cartridge being rolled;

FIG. 3 is a section detail view of the cartridge along line 3-3 in FIG. 2;

FIG. 4 is an exploded view of the cartridge; and

FIG. 5 is detail view of the chicken feather carbon micro-tubes.

### SUMMARY OF THE INVENTION

The invention is generally a cylindrical cartridge comprising a layer of baked bird feathers and a layer of fiberglass adjacent to said layer of bird feathers, wherein both of said layers are rolled together to form a unitary cylinder.

The invention is also a method of forming a cylindrical cartridge, including the steps of positioning at least one layer of fiberglass in a substantially planar orientation; adding a layer of bird feathers on top of said layer of fiberglass to form a composite bilayer; rolling said bilayer; and heating said bilayer.

The invention is also system of reducing overall energy consumption including a storage tank; a cylindrical cartridge comprised of a rolled bilayer of baked bird feathers and fiberglass, said cylindrical cartridge within said storage tank; and a liquid fuel within said storage tank.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

It should also be understood that ranges of values set forth inherently include those values, as well as all increments between. It should also be understood that ranges of values set forth inherently include those values, as well as all increments between. Moreover, as used herein, “approximately” means +/−5%. If approximately refers to an unquantifiable character, “approximately” means as reasonably accomplished but allowing for human error. “Fluid” as used herein means both liquid and gas state, although it should be understood that when referring to one or the other, it is the preponderance of the material state, notwithstanding the fact that phases dynamically change.

The following structure numbers apply to the following structures among the various FIGS:

10 is a layered cylindrical rolled cartridge;

12 is a bird feather;

14 is a bird feather layer/carbon microtubule layer micro/nanotubes mesh;

16 is a fiberglass layer;

18 is a pressurized gas tank; and

20 is a nanotube/micro-tube.

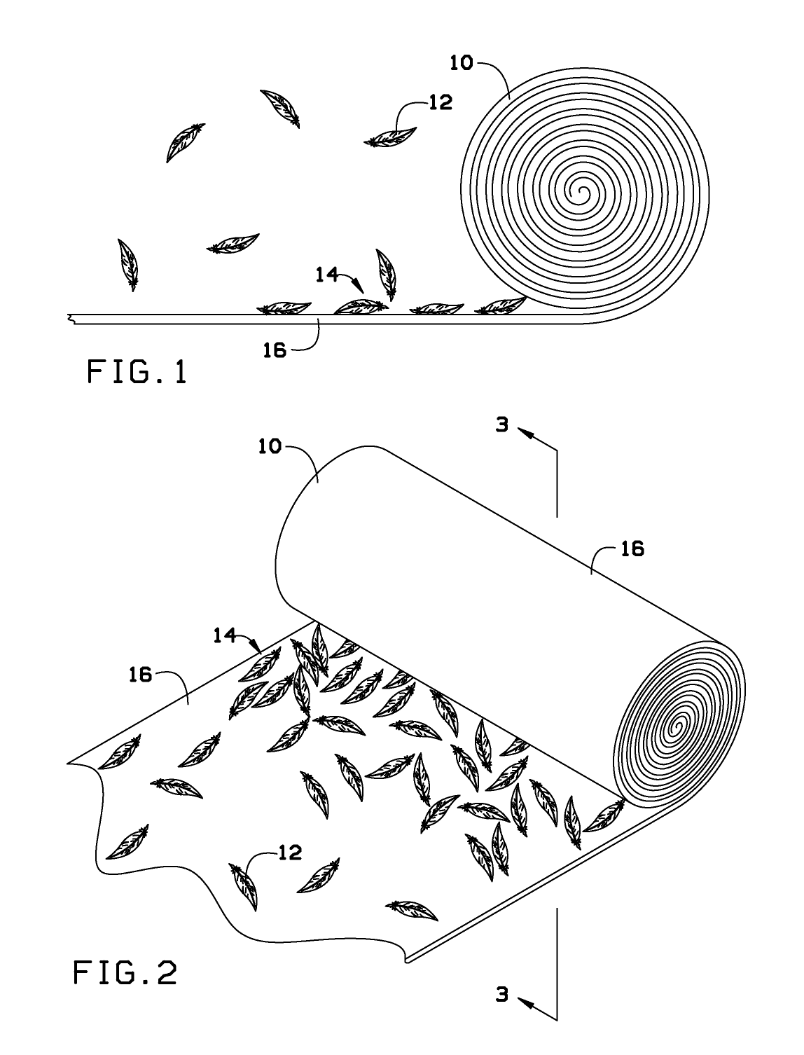

As shown in FIG. 1, the general orientation of cartridge 10 is a rolled bilayer including fiberglass layer 16 acting as a stabilizing substrate, and individual bird feathers 12 forming feather layer 14 on top of fiberglass layer 16. Note that FIGS. 1 and 2 depict feather layer 14 as a discontinuous layer for illustrative purposes only. Feather layer 14 is approximately 4 mm to 8 mm thick, and fiberglass layer 16 is 2 mm to 4 mm thick. Fiberglass layer 16 may be formed of one layer, or multiple sheets which collectively form a layer of 2 mm to 4 mm thick.

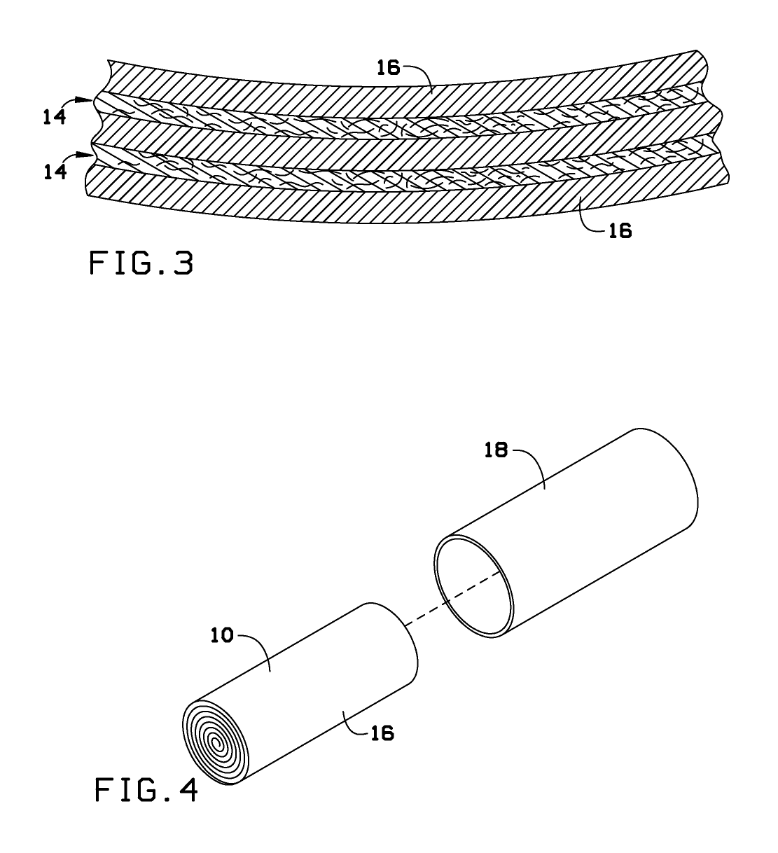

FIG. 3 depicts a small exemplary section of the orientation of layers upon rolling and baking, with alternating layers of fiberglass layer 16, feather layer 14, fiberglass layer 16, and so forth. Note that FIG. 3 depicts 5 layers, but actual cartridge 10 could as many layers as desired in order to substantially fill the volume of the tank.

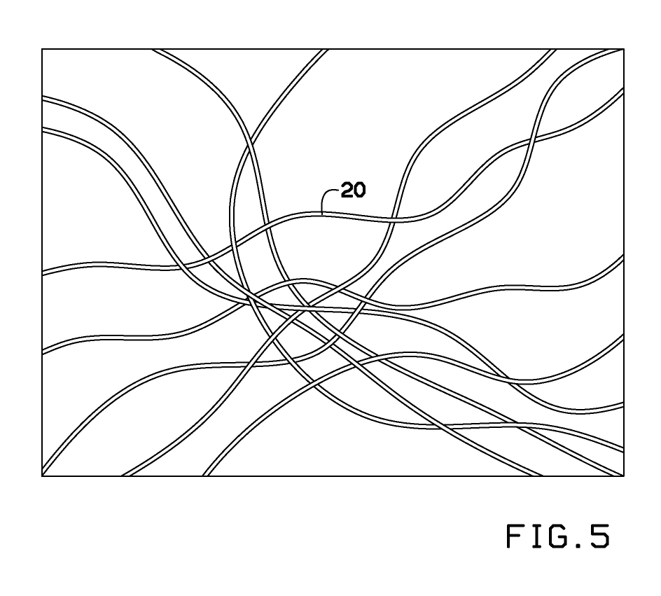

The rolled bilayer is baked at approximately 750° F. in an environment substantially free of O₂, for approximately 1 hour. Ideally the substantially O₂-free heating chamber is filled with CO₂. Other gasses such as nitrogen could be used, just so long as environment is flushed of free oxygen, but CO₂ is desirable because it serves the dual purpose of activating the carbon. Following the baking process, the cylindrical bilayer is allowed to cool slowly, i.e., at room temperature. When cooled, cartridge 10 can be stored or used immediately. For use, the cartridge 10 is inserted into tank 18 (generically set forth in FIG. 4), and activated by adding CO₂ gas. Activation improves the adsorbancy of carbonized tubules by etching the walls of the carbon nanotubues, thereby producing nano pockets. Nano pocket formation results in a surface area increase of up to 450 square meters per gram of feathers. This drastically improves the storage capacity of methane or hydrogen fluid.

From a structural standpoint, carbonized feathers 12 become microtubules that act as nanotubules for the adsorption of methane or hydrogen gas molecules, similar to how activated charcoal is used in medicine and aquariums. The resulting nano pockets facilitate adsorption. In fact, in a side by side comparison of tanks with and without cartridges, tanks with cartridges fueled a flame for 40% to 50% longer than tanks without cartridges. Fiberglass layer 16 allows the free flow of gasses between carbon microtubules. Although the layers 14 and 16 can remain more or less distinct one from another, it is advantageous to weave, comb or otherwise entangle them.

It is advantageous to use the system described herein in a fashion that is minimizes energy consumption in times of high energy demand. For example, it is desirable to use excess or unused nighttime electricity to electrolyze water, and store the hydrogen and oxygen gas in rail tanks or nearby tank farms. Also, windmills, nearby gas reserves and other systems off the main electrical grid can pump gas into rail tanks or tank trucks, with one rail tank with methane replacing one coal car and the associated pollution. Also, excess solar power, that can't be transmitted onto the grid, can be used to electrolyze water into hydrogen and oxygen gasses, with the gasses stored in tanks using cartridges of the present invention. These gas tanks could be used when the sun is not shining. Also, geothermal electrical excess power can also be used to electrolyze water and store the gasses, as previously described.

It should be understood, of course, that the foregoing relates to exemplary embodiments of the invention and that modifications may be made without departing from the spirit and scope of the invention as set forth in the following claims. For example, it would be possible to modify the invention described by creating a non-cylindrical cartridge shape, such as rectangular or pillow like, or other shapes, for example by stacking the layers into a sleeve and baking.

What is claimed is:

1. A cylindrical cartridge comprising:
a layer of baked bird feathers; and
a layer of fiberglass adjacent to said layer of bird feathers, wherein both of said layers are rolled together to form a unitary cartridge.

2. The cylindrical cartridge of claim 1 wherein said layer of baked bird feathers is approximately 4 mm-8 mm thick.

3. The cylindrical cartridge of claim 1 wherein said layer of fiberglass is approximately 2 mm-4 mm thick.

4. The cylindrical cartridge of claim 1 wherein said layer of baked bird feathers is woven together with said layer of fiberglass.

5. The cylindrical cartridge of claim 1 wherein said layer of baked bird feathers is combed together with said layer of fiberglass.

6. The cylindrical cartridge of claim 1 wherein said layer of baked bird feathers and said layer of fiberglass are entangled.

7. A method of forming a cylindrical cartridge, said method including the steps of:
positioning at least one layer of fiberglass in a substantially planar orientation;
adding a layer of bird feathers on top of said layer of fiberglass to form a composite bilayer;
rolling said bilayer; and
heating said bilayer.

8. The method of claim 7 wherein said step of heating said bilayer includes the step of heating at approximately 750° F.

9. The method of claim 7 wherein said step of heating said bilayer includes the step of heating for approximately 1 hour.

10. The method of claim 7 wherein said step of heating said bilayer includes the step of heating said bilayer in an environment free of O₂.

11. A system of reducing energy consumption, said system including:
a storage tank;
a cylindrical cartridge comprised of a rolled bilayer of baked bird feathers and fiberglass, said cylindrical cartridge disposed within said storage tank; and
liquid fuel within said storage tank.

12. The system of claim 11 wherein said storage tank is connected to a vehicle, and fuels said vehicle.

13. The system of claim 11 wherein said storage tank is a railcar.

14. The system of claim 11 wherein said liquid fuel is methane.

15. The system of claim 11 wherein said liquid fuel is hydrogen gas.
